(19) United States
(12) Patent Application Publication
(10) Pub. No.: US 2019/0017603 A1
(43) Pub. Date: Jan. 17, 2019

(54) SEALING STRUCTURE OF RECIPROCATING PLUNGER PUMP

(71) Applicant: Zhejiang Rongpeng Air Tools Co., Ltd., Taizhou (CN)

(72) Inventors: Xiaorong Li, Taizhou (CN); Fazheng Yang, Taizhou (CN); Zhenxing Ying, Taizhou (CN); Bo Chen, Taizhou (CN)

(73) Assignee: Zhejiang Rongpeng Air Tools Co., Ltd., Taizhou (CN)

(21) Appl. No.: 15/647,270

(22) Filed: Jul. 12, 2017

(51) Int. Cl. F16J 15/3232; F04B 19/22; F04B 53/14; F04B 53/10; F16J 15/3208

(52) U.S. Cl. CPC F16J 15/3232; F04B 19/22; F16J 15/3208; F04B 53/10; F04B 53/144

(57) ABSTRACT

A sealing structure of a reciprocating plunger pump comprises a pump seat, a pressure relief valve assembly, a pressure regulating valve assembly, and a plunger rod assembly; the plunger rod assembly includes a plunger rod, a large sealing ring and a small sealing ring; the structure of the large sealing ring is the same as that of the small sealing ring, and the large sealing ring includes a ring-shaped sealing body, an annular recess, and an annular tension spring; the annular tension spring always has an outwardly expanding force on both side walls of the annular recess; the sealing body includes a saw-tooth sealing groove. The sealing structure reduce the load on the pump and improve the service life of the sealing ring.

### BACKGROUND OF THE INVENTION

### (1) Field of the Invention

The present invention relates to a sealing structure of a reciprocating plunger pump.

### (2) Description of the Related Art

High-pressure spray widely used in the home latex paint spray waterproof, anti-corrosion, steel corrosion and other spraying operations, compared to the traditional artificial spray, which greatly improves the efficiency and reduce labor intensity. Spraying machine, the core component is the plunger pump, and the core components of the plunger pump are plunger rod and sealing ring which are the wearing parts, therefore, how to extend the service life of plunger rod and sealing ring has become a major issue in the art.

### SUMMARY OF THE INVENTION

The technical problem to be solved by the present invention is to provide a sealing structure of a reciprocating plunger pump, which can extend the service life of the sealing ring and reduce the maintenance cost.

In order to solve the above technical problems, the technical solution is to provide a sealing structure of a reciprocating plunger pump, comprising a pump seat, a pressure relief valve assembly disposed on the pump seat, a pressure regulating valve assembly, and a plunger rod assembly disposed in the pump seat; wherein the plunger rod assembly includes a plunger rod, a large sealing ring and a small sealing ring sleeved on the plunger rod; the large seal ring is disposed in a lower retaining groove of the pump seat, and the small sealing ring is disposed in an upper retaining groove of the pump seat; the structure of the large sealing ring is the same as that of the small sealing ring, and the large sealing ring includes a ring-shaped sealing body, an annular recess which is disposed on one end of the sealing body and formed as a V-shape in cross-section thereof, and an annular tension spring disposed in the annular recess and formed as a V-shape in cross-section thereof; wherein the annular tension spring always has an outwardly expanding force on both side walls of the annular recess; the sealing body includes a saw-tooth sealing groove disposed in an inner wall thereof, at least a groove disposed in an outer wall thereof, and a seal ring disposed in the groove.

The technical effect achieved, by the present invention is:

Compared with the prior art, when the reciprocating plunger pump is in operation and the seal ring, the outer wall of the sealing body or the sealing lips are worn due to prolonged use, the annular tension spring has an outward force acting on the both side walls of the annular recess of the sealing body which allows the both sides of the annular recess are expanded outwardly about the annular recess, so that the inner wall of the sealing body is tightly attached to the plunger rod, and the seal ring of the outer wall of the sealing body is tightly attached to the retaining groove to compensate for the amount of interference and maintain the shape of the sealing body.

The saw-tooth sealing groove is located on and is in contact with the plunger rod (4) at a relative movement, which can automatically compensate for the amount of interference based on pressure and wear conditions, reducing the load on the pump and improving the service life of the sealing ring.

### BRIEF DESCRIPTION OF DRAWINGS

FIG. 1 is a schematic view of a sealing structure of a reciprocating plunger pump of the present invention;

FIG. 2 is a cross-sectional view taken along line A-A of FIG. 1;

FIG. 3 is a schematic view of a small sealing ring according to the present invention.

### DETAILED DESCRIPTION OF THE INVENTION

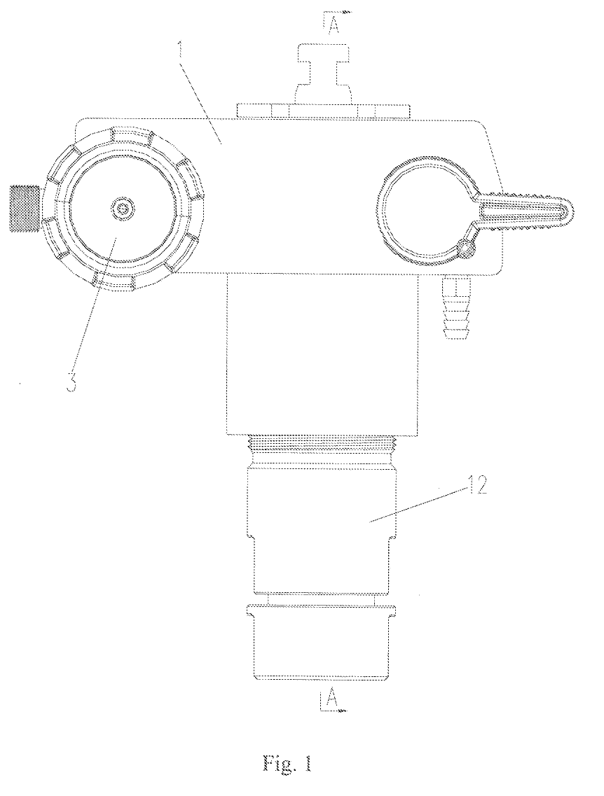

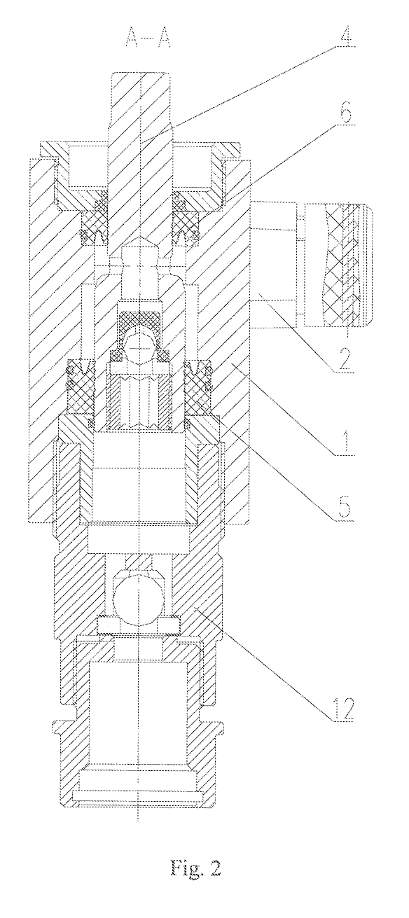

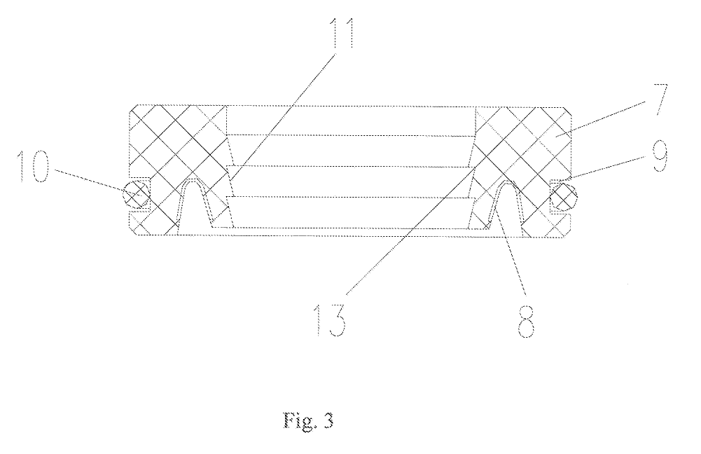

Referring to FIGS. 1-3, the present invention provides a sealing structure of a reciprocating plunger pump, comprising a pump seat (1), a pressure relief valve assembly (2) disposed on the pump seat (1), a pressure regulating valve assembly (3), and a plunger rod assembly disposed in the pump seat. The plunger rod assembly includes a plunger rod (4), a large sealing ring (5) and a small sealing ring (6) sleeved on the plunger rod (4); the large seal ring (5) is disposed in a lower retaining groove (not shown) of the pump seat (1), and the small sealing ring is disposed in an upper retaining groove (not shown) of the pump seat (1); the structure of the large sealing ring (5) is the same as that of the small sealing ring (6), and the large sealing ring includes a ring-shaped sealing body (7), an annular recess (not shown) which is disposed on one end of the sealing body (7) and formed as a V-shape (not shown) in cross-section thereof, and an annular tension spring (8) disposed in the annular recess and formed as a V-shape in cross-section thereof, wherein the annular tension spring (8) always has an outwardly expanding force on both side walls of the annular recess; the sealing body (7) includes a saw-tooth sealing groove disposed in an inner wall thereof, at least a groove (9) disposed in an outer wall thereof, and a seal ring (10) disposed in the groove (9).

Specifically, the outer wall of the sealing body (7) of the large sealing ring (5) is provided with two grooves (9), and the outer wall of the sealing body (7) of the small sealing ring (6) is provided with a groove (9).

The following describes the working principle of the present invention:

The sealing structure of the reciprocating plunger pump of the present invention has a large sealing ring (5) and a small sealing ring (6), both of the sealing rings are static sealing, the seal ring (10) of the outer wall of the sealing body (7) abuts against the inner wall of the retaining groove, the saw-tooth sealing groove of the sealing body (7) forms a plurality of sealing lips (11), the sealing lips are fitted to an outer wall of the plunger rod (4) to form a seal; when the seal ring (10), the outer wall of the sealing body (7) or the sealing lips (11) are worn due to prolonged use, the annular tension spring (8) has an outward force acting on the both side walls of the annular recess of the sealing body (7) which allows the both sides of the annular recess are expanded outwardly about the annular recess, so that the inner wall of the sealing body (7) is tightly attached to the plunger rod (4), and the seal ring (10) of the outer wall of the sealing body (7) is tightly attached to the retaining groove to compensate for the amount of interference and maintain the shape of the sealing body. When the reciprocating plunger pump is in operation, the greater the pressure in a pump body (12), the greater the pressing force of the medium in the pump body (12) to the large and small sealing rings, and the better the sealing effect; when the sealing rings are worn, the annular tension spring (8) compensates for the amount of interference and maintain the shape of sealing rings. The saw-tooth sealing groove is located on and is in contact with the plunger rod (4) at a relative movement, which can automatically compensate for the amount of interference based on pressure and wear conditions, reducing the load on the pump and improving the service life of the sealing ring. According to the experiment, the sealing structure of the present invention has doubled the life of the conventional multi-lip seal.

The above only describes some exemplary embodiments of the present invention. Those having ordinary skills in the art may also make many modifications and improvements without departing from the conception of the invention, which shall all fall within the protection scope of the invention.

1. A sealing structure of a reciprocating plunger pump, comprising a pump assembly (1), a pressure relief valve assembly (2) disposed outside of the pump assembly (1), a pressure regulating valve assembly (3) is located on the pump assembly on the same side of the pressure relief valve assembly, and a plunger rod assembly disposed inside the pump assembly (1) and an upper part thereof being exposed above the pump assembly;
wherein the plunger rod assembly includes a plunger rod (4), a large sealing ring (5) and a small sealing ring (6) sleeved on the plunger rod (4); the large seal ring (5) is disposed in a lower retaining groove of the pump assembly (1), and the small sealing ring is disposed in an upper retaining groove of the pump assembly (1); the structure of the large sealing ring (5) is the same as that of the small sealing ring (6), and the large sealing ring includes a ring-shaped sealing body (7), an annular recess which is disposed on one end of the sealing body (7) and formed as a V-shape in cross-section thereof, and an annular tension spring (8) disposed in the annular recess and formed as a V-shape in cross-section thereof;
wherein the annular tension spring (8) always has an outwardly expanding force on both side walls of the annular recess; the sealing body (7) includes a saw-tooth sealing groove disposed in an inner wall thereof, at least a groove (9) disposed in an outer wall thereof, and a seal ring (10) disposed in the groove (9); the plunger rod (4) is formed with a tooth-shaped structure corresponding to the sealing groove of the sealing body (7).
